(19) United States
(12) Patent Application Publication
(10) Pub. No.: US 2002/0068033 A1
(43) Pub. Date: Jun. 6, 2002

(54) GRAPHITE FIBRIL MATERIAL

(76) Inventors: HIROHARU IKEDA, TOKYO (JP); PAUL R. NAHASS, CAMBRIDGE, MA (US); ROBERT HAUSSLEIN, LEXINGTON, MA (US)

Correspondence Address: BARRY EVANS, ESQ., KRAMER LEVIN NAFTALIS & FRANKEL LLP, 919 Third Avenue, New York, NY, 10022, US

(21) Appl. No.: 08/612,914

(22) PCT Filed: Sep. 9, 1994
(86) PCT No.: PCT/US94/10169

(30) Foreign Application Priority Data
Sep. 10, 1993 (JP) 5/226043

(51) Int. Cl. D01F 9/12; C01B 31/04

(52) U.S. Cl. 423/447.2; 423/448; 423/447.3

(57) ABSTRACT

A graphite fibril material comprised primarily of an aggregate of an average particle diameter of 0.1 to 100 μm in which fibrils are intertwinned, the fibrils being graphite fibrils of a fiber diameter of 0.0035 to 0.075 μm and spacing of the carbon hexagonal net plane as determined by the X-ray diffraction method of 3.36 to 3.53 angstroms. It is of high crystallinity and purity and is of superior conductivity, chemical stability, solvent absorption capacity and reinforcing capacity.

### FIELD OF THE INVENTION

This invention relates to graphite fibrils and an aggregate thereof.

### BACKGROUND OF THE INVENTION

Extremely fine carbon fibrils obtained by the gaseous phase method and aggregates thereof have superior conductivity and reinforcing capacity and are useful as battery materials conductive rubber and conductive plastics. However, they generally do not possess a high degree of crystallinity and purity. Consequently, there have been problems with regard to uses in which higher conductivity and purity are required.

For example, the carbon fibrils that are described in Japanese Patent Disclosure No. 62-500943 [1987] and Japanese Patent Disclosure No. 2-503334 [1990] have manufacturing temperatures of 400 to 1200° C., the carbon fibrils that are obtained are of low crystallinity and the intervals between adjacent layers are the sort of intervals seen with single crystal graphite, that is, they are only slightly greater than approximately 0.339 to 0.348 nm. Further, as will be described subsequently, as a result of determinations by Raman scattering spectra, X-ray diffraction, X-ray photoelectric spectroscopy (XPS) and plasma emission analysis (ICP-AES), these carbon fibrils were found to be of low crystallinity, to exhibit a low surface carbon purity and to have a high metal content.

As described in Japanese Patent Disclosure No. 61-225320 [1986], carbon fibers of 1.3 to 1.5 m in diameter obtained by gaseous phase method are heated to 2500° C., with a product have a spacing (d002) as determined by X-ray diffraction of 3.36 angstroms (hereafter abbreviated as Å).

Further, as described in Japanese Patent Disclosure No. 61-225325 [1986], carbon fibers of 0.15 μm in diameter obtained by the gaseous phase method are heated to 2400° C., with a product of a d002 of less than 3.40 Å.

As described in Japanese Patent Disclosure No. 63-282313 [1988], hollow carbon fibers of 0.006 μm in diameter obtained by the gaseous phase method are heated to 2400° C., with a product in which d002=3.36 Å and in which the crystallite size Lc in the C axis direction is 20 Å (less than 100 Å).

However, the hollow carbon fiber described above are not of high crystallinity and purity and they do not have continuous hot carbon characteristics. There are no descriptions whatsoever of fibrils of a fine tubular shape having multiple graphite layers that are essentially parallel to the fibril axis or of aggregates of specified particle diameters with which they are intertwined.

### OBJECTS OF THE INVENTION

It is therefore a general object of the invention to provide fine graphite fibrils of high crystallinity and purity, and aggregates in which they are intertwined.

This and other objects, features and advantages of the invention will become readily apparent from the ensuing description, and the novel features will be particularly pointed out in the appended claims.

### SUMMARY OF THE INVENTION

This invention is directed to a graphite fibril material characterized in that the fiber diameter is greater than 10, the spacing (d002) of the carbon hexagonal net plane (002) as determined by the X-ray diffraction method is 3.63 to 3.53 angstroms, the diffraction angle (2θ) is 25.2 to 26.4 degrees, the 2θ band half-width is 0.5 to 3.1 degrees, the ratio pf the peak height (Ic) of the bands at 1570 to 1578 cm⁻¹ of the Raman scattering spectrum and the peak height (Ia) of the bands at 1341 to 1349 cm⁻¹ (Ic/Ia) is greater than 1, the ratio of the relative presence of C_{IS} and O_{IS} (C_{IS}/O_{IS}) found by X-ray photoelectric spectroscopy is greater than 99/1 and the metal content as determined by the plasma emission analysis is less than 0.02% and in that it is comprised primarily of an aggregate of an average particle diameter of 0.1 to 100 μm which has an outside region comprised of continuous multiple layers of carbon atoms of a regular arrangement and of a noncontinuous hollow internal core region and in which the graphite fibrils, in which the layers and the core are arranged concentrically around the cylindrical axis of the fibrils, are intertwined.

### DETAILED DESCRIPTION OF THE INVENTION

This invention is directed to a graphite fibril material. The diameter of the graphite fibrils of this invention should be 0.0035 to 0.075 μm, preferably, 0.005 to 0.05 μm, and, more preferably, 0.007 to 0.4 μm. When the diameter is less than 0.0035 m, manufacture is difficult. When it exceeds 0.075 μm, surface area is decreased, which will decrease reinforcing capacity, conductivity and adsorption capacity.

Fiber length/fiber diameter of the graphite fibrils should be greater than 10, preferably greater than 50, and, more preferably, greater than 100. When this ratio is less than 10, reinforcing capacity and conductivity are reduced and it becomes difficult to form an aggregate structure in which fibrils are intertwined.

The spacing (d002) of the carbon hexagonal net plane of the graphite fibrils as determined by the X-ray diffraction method should be 36.3 to 3.53 Å, and, preferably, 3.38 to 3.48 Å, the diffraction angle (20) should be 25.2 to 26.4 degrees, and, preferably, 25.9 to 26.3 degrees, and the 2θ band half-width should be 0.5 to 3.1 degrees, and, preferably, 0.6 to 1.6 degrees.

When the spacing exceeds 3.53 Å or the diffraction angle is less than 25.2 degrees, crystallinity is not sufficient and conductivity is decreased. When spacing is less than 3.36 Å and the diffraction angle exceeds 26.4 degrees, manufacture of the carbon fibrils becomes difficult.

When the 2θ band half-width is less than 0.5 degrees, manufacture is difficult. When it exceeds 3.1 degrees, crystallinity is not sufficient and conductivity is decreased.

The ratio of the peak height (Ic) of the 1570-1578 m⁻¹ band of the Raman scattering spectrum and the peak height (Ia) of the 1341-1349 cm⁻¹ band (Ic/Ia) should be greater than 1, and, preferably, greater than 2, and the ratio C_{IS}/O_{IS} as determined by XPS should be greater than 99/1, preferably, greater than 99.5/0.5, and, more preferably, greater than 99.8/0.2. The metal content as determined by ICP-AES should be less than 0.02% (by weight), preferably, less than 0.01% by weight, and, more preferably, less than 0.005%. When the ratio C_{IS}/O_{IS} is less than 99/1 and when the metal content exceeds 0.02%, this is not desirable because the battery materials do not readily undergo chemical reactions.

The average particle diameter of the aggregate with which the graphite carbon fibrils are intertwined should be 0.1 to 100 μm, preferably, 0.2 to 30 μm, and, more preferably, 0.3 to 10 μm.

When the average particle diameter is less than 0.1 μm, manufacture is difficult. When the average particle diameter is greater than 100 μm, dispersibility, conductivity and reinforcing capacity are decreased.

The terms “average particle diameter” and “90% diameter” are used in describing the size of the aggregate of this invention. These terms are defined as follows.

The particle size distribution when d is taken as the particle diameter and the volumetric ratio Vd at this particle diameter is taken as the probability variable is called D. The specific particle diameter at which the total obtained by summing the volumetric ratios from the smallest particle diameter to a certain particle diameter is half the entire particle size distribution D is defined as the average particle diameter dm. Similarly, the specific particle diameter at which the total obtained by summing the volumetric ratios from the smallest particle diameter to a certain particle diameter so that it is 90 percent of the total distribution is defined as the 90% diameter.

The graphite fibril material that is used in this invention is comprised for the most part of an aggregate in which fine filamentous graphite fibrils of 0.0035 to 0.075 μm are intertwined. The proportion of aggregate in the carbon graphite material should be greater than 30%, and, preferably, greater than 50%.

Determination of the particle diameters of the aggregate is performed as follows. The carbon fibril material is introduced into an aqueous solution of surfactant and an aqueous dispersion is made by treatment with an ultrasonic homogenizer. Determinations are made using a laser diffraction scattering type particle size distribution meter with this aqueous dispersion as the test material.

The graphite fibrils of this invention and the graphite fibril material comprised primarily of an aggregate in which they are intertwined can be manufactured using carbon fibrils manufactured by the methods described, for example, in Japanese Patent Disclosure No. 3-503334 [1990] or Japanese Patent Disclosure No. 62-500943 [1987] as the raw material and by heating it at 2000 to 3500° C., preferably, 2300 to 3000° C., more preferably, greater than 2400° C., and, most preferably, greater than 2450° C. in a vacuum or in an inert gas atmosphere such as argon, helium or nitrogen either in unaltered from or after a chemical treatment such as removal of the catalyst carrier by treatment with an acid or alkali or adjustment to a specified particle diameter by pulverization treatment or after both have been performed. When carbon fibrils are subjected to heat treatment in unaltered form, the target substance can be obtained by performing chemical treatment and pulverization treatment after heating.

The pulverization device is, for example, an air flow pulverizer (jet mill) or an impact pulverizer. These pulverizers can be connected with each other. Because the treatment volume per unit time is greater than that with a ball mill or a vibrating mill, pulverization costs can be lowered. Further, by installing a grading mechanism in the pulverizer or installing a grading device such as a cyclone in the line, there is the desirable effect that a carbon fibril aggregate of a narrow, uniform particle size distribution can be obtained.

Heat-treating at extremely high temperatures showed fibrils with straight layered lattice planes in the direction of the fiber axis. This heat treatment produces a material with advantageous properties such as no ash (eliminate washing), better conductivity, higher service temperature and higher modulus.

There are no particular limitations on the heating method. For example, heating with an electric furnace, infrared heating, plasma heating, laser heating, heating by electromagnetic induction, utilization of fuel heat and utilization of heat of reactions may be used. Although there are no particular limitations on heating time, it is ordinarily 5 to 60 minutes.

The invention will now be more fully described and understood with reference to Examples 1 through 3, Comparative Examples 1 and 2 and Reference Examples 1 through 3. These examples are given by way of illustration and the claimed invention is not limited by these examples.

### EXAMPLE 1

Fibrils of 0.013 μm in diameter that had been subjected to phosphoric acid treatment and pulverization treatment and an aggregate of an average particle diameter of 3.5 μm and an aggregate 90% diameter of 8.2 μm were used as the raw material carbon fibril materials.

The materials were heated for 60 minutes at 2450° C. in a helium gas pressurized induction furnace. As a result of determination of the graphite fibril obtained under a transmission electron microscope, the fibrils were found to be of a fine filamentous tubular shape having a graphite layer essentially parallel to the fibril axis. The diameters of the fibrils were the same as those of the raw materials and the structure of the aggregate in which the fibrils were intertwined were spherical or elliptical. The average particle diameter of the aggregate was 3.2 μm and its 90% diameter was 6.4 μm. Table 1 shows the results for Ic/Ia ratio determined by Raman analysis, for the C_{IS}/O_{IS} ratio determined by the X-ray diffraction method and XPS and of analysis of metal content (the principal component being iron) determined by plasma emission analysis.

### EXAMPLE 2

Analysis was performed using the same procedure raw material from Example 1, except that heating was performed at 2400° C.

### Comparative Examples and Reference Examples

Comparative Example 1 is the result of the analysis with the configuration of the raw material carbon fibrils (A). Comparative Example 2 was performed at a heating temperature of 1800° C. for 60 minutes. The results are shown in Table 1 and Table 2 below.

Table 2 shows the results of analysis for acetylene black (AB; manufactured by Denki Kagaku company) as Reference Example 1, for acetylene black EC-DJ-500 (XB; sold by the Lion Akuso Company) as Reference Example 2 and for graphite as Reference Example 3.

TABLE 1

| | | | | Comparative | |
|---|---|---|---|---|---|
| | Examples | | | Examples | |
| | 1 | 2 | 3 | 1 | 2 |
| Raw Material | A | A | A | A | A |
| Heating | 2450 | 2400 | 2200 | — | 1800 |
| Temperature ° C. | | | | | |
| Shape of Product | | | | | |
| Diameter μm | 0.013 | 0.013 | 0.013 | 0.013 | 0.013 |
| Average | 3.2 | 3.3 | 3.7 | 3.5 | 3.7 |
| particle | | | | | |
| diameter μm | | | | | |
| 90% diameter μm | 6.4 | 6.8 | 8.3 | 8.2 | 8.3 |
| x-ray diffraction | | | | | |
| method | | | | | |
| Diffraction angle | 26.2 | 25.9 | 25.3 | 25.3 | 25.1 |
| degrees | | | | | |
| Spacing Å | 3.40 | 3.43 | 3.52 | 3.54 | 3.54 |
| Half-width Å | 0.84 | 1.3 | 3.0 | 3.2 | 3.0 |
| Raman Ic/Ia | 2.2 | 2.0 | 1.1 | 0.69 | 0.75 |
| XPS | | | | | |
| C_{IS} /O_{IS} | 100/0 | 100/0 | 100/0 | 98/2 | — |
| Metal content % | <0.01 | <0.01 | <0.01 | 1.2 | <0.01 |

TABLE 2

| | Reference Examples | | |
|---|---|---|---|
| | 1 | 2 | 3 |
| Raw Material | AB | B | graphite |
| Heating Temperature | — | — | — |
| ° C. | | | |
| Shape of Product | | | |
| Diameter μm | — | — | — |
| Average particle μm | — | — | — |
| diameter | | | |
| 90% diameter μm | — | — | — |
| x-ray diffraction | | | |
| Diffraction angle | 25.5 | 24.9 | 26.5 |
| degrees | | | |
| Spacing Å | 3.49 | 3.58 | 3.36 |
| Half-width Å | 2.3 | 5.7 | 0.5 |
| Raman Ic/Ia | — | — | — |
| XPS | | | |
| C_{IS}/O_{IS} | — | — | — |
| Metal content % | — | — | — |

### EXAMPLE 3

100 mg of the graphite fibrils of Example 1 was introduced into a cell of 8 mm in inside diameter and 80 mm in height made of Dalrin Table 3 shows the results of determinations of electric resistance values (electric conductivity) when compression was effected with a steel cylinder-electrode together with the results for determination of the raw material carbon fibrils of Comparative Example 1.

TABLE 3
Resistance Values of Fibrils (ohm)

| | | | |
|---|---|---|---|
| Compression pressure (kg/cm²) | 70 | 110 | 150 |
| Heating temperature, 2450° C. | 24 | 11 | 7 |
| Without heating | 35 | 29 | 26 |

From the relationship between pressure and resistance values during compression, it can be seen that the fibrils obtained at 2450° C. exhibit an essentially inverse proportional relationship. Since the resulting fibrils is smaller than in the raw material fibrils, it can be seen that the compression molding capacity was effective.

### EXAMPLE 4

Fibrils designated BN-1100, were 136-08 was heat-treated using a carbon tube furnace fitted with an optical pyrometer (recently-calibrated) to monitor temperature. Ultrahigh-purity argon flowed through the chamber at about 1 scfh. The argon was gettered (heated in a reducing atmosphere to 600° C.) to remove any residual oxygen which would easily oxidize fibrils at the temperatures encountered.

The temperature of the outermost portion of the samples was monitored with the pyrometer. The measured temperature therefore represents the lowest temperature the samples were exposed to at that time. Two graphite crucibles (1″ dia., 2″ long) with screw caps and porous bases were loaded each with 0.66 g of BN-1100. The porous bases faced counter to Ar flow to facilitate gas flow to and from sample chambers.

Fibril samples were taken to >2790° C. and held for 1 hour. The centerline furnace temperature was probably about 2950° C. during this time (based on previous furnace profile calibration). Results of this experiment is summarized in Table 4 below.

TABLE 4

| | Untreated | Heat-Treated |
|---|---|---|
| Dustiness | dusty | not dusty |
| Pourability | good | poor |
| Magnetism | some | none |
| Viscosity | normal | very low |
| Vol. Resistivity | 19,200 | <10⁹ |
| (ohm-cm) | | |
| Density (g/cc) | 0,084 | 0.100 |
| Ash Content (wt %) | 9.9 | 0.3 |
| Microscopy | wavy lattice planes | straight |
| lattice planes | gradual curves | sharp angles |

1.05g of fibrils were recovered after heat-treatment. This indicates a 20% weight loss upon heating. Production logs indicated a 12.5% yield on 136-08, corresponding to 8 wt % non-carbonaceous matter present. The rest of the weight loss on heating can be attributed to reaction of carbon with oxygen generated by Al₂O₃ reduction (2% of fibril wt. loss) and the rest to adventitious oxygen present in the furnace during heat treatment. This trial demonstrated that improved purity and crystallinity were made by the high temperature annealing. Also evident is the reduction in ash and in magnetism. The data showed reduced conductivity and viscosity in mineral oil after annealing and reflect the fact that the fibrils become more “cemented” together as a result of annealing and can no longer be easily dispersed into a network within the body of the mineral oil. The true or inherent conductivity of the fibrils was undoubtedly increased by annealing.

The fine tubular graphite fibrils of this invention, and the graphite fibril material comprised primarily of aggregate in which they are intertwined, have high crystallinity and purity and good conductivity, reinforcing capacity chemical stability, solvent absorption capacity and molding capacity. As a result, the fibrils and the aggregate can be compounded with battery material for manganese batteries, alkaline batteries as well as lithium batteries and with rubber resins, ceramics, cement and pulp to increase conductivity and reinforcing effect.

Having thus described in detail preferred embodiments of the present invention, it is to be understood that the invention defined by the appended claims is not limited to particular details set forth in this description as many variations thereof are possible without departing from the spirit or scope of the present invention.

What is claimed is:

1. A graphite fibril material characterized in that the fiber diameter is 0.0035 to 0.075 μm, the fiber length/fiber diameter is greater than 10, the spacing (d002) of the carbon hexagonal net plane (002) as determined by the X-ray diffraction method is 3.63 to 3.53 angstroms, the diffraction angle (26) is 25.2 to 26.4 degrees, the 2θ and half-width is 0.5 to 3.1 degrees, the ratio pf the peak height (Ic) of the bands at 1570 to 1578 cm⁻¹ of the Raman scattering spectrum and the peak height (Ia) of the bands at 1341 to 1349 cm⁻¹ (Ic/Ia) is greater than 1, the ratio of the relative presence of C_{IS} and O_{IS} (C_{IS}/O_{IS}) found by X-ray photoelectric spectroscopy is greater than 99/1 and the metal content as determined by the plasma emission analysis is less than 0.02% and in that it is comprised primarily of an aggregate of an average particle diameter of 0.1 to 100 μm which has an outside region comprised of continuous multiple layers of carbon atoms of a regular arrangement and of a noncontinuous hollow internal core region and in which the graphite fibrils, in which the layers and the core are arranged concentrically around the cylindrical axis of the fibrils, are intertwined.
